(19) United States
(12) Patent Application Publication
(10) Pub. No.: US 2020/0002900 A1
(43) Pub. Date: Jan. 2, 2020

(54) ARTIFICIAL TURF FIELD APPARATUS AND METHODS

(71) Applicant: FieldTurf, Inc., Montreal (CA)

(72) Inventors: Alain Bissonnette, Montreal (CA); Cameron St. Dennis, Montreal (CA); Alexandre Laporte, Montreal (CA)

(21) Appl. No.: 16/457,574

(22) Filed: Jun. 28, 2019

Related U.S. Application Data
(60) Provisional application No. 62/692,590, filed on Jun. 29, 2018.

(51) Int. Cl. E01C 13/08; B32B 5/16

(52) U.S. Cl. CPC E01C 13/08; B32B 5/16

(57) ABSTRACT

An artificial turf athletic playing field comprising a first layer of artificial turf comprising artificial grass fibers tufted through a first backing and a first infill layer comprising infill particles interspersed between the tufted fibers, wherein the backing incorporates water drainage arranged by drainage openings dispersed throughout the backing that are covered by infill particles and tufted fibers, and wherein the infill layer has been leveled to be in a leveled condition; and a second layer of artificial turf comprising artificial grass fibers tufted through a second backing and a second infill layer comprising infill particles interspersed between the tufted fibers, wherein the second layer is configured to receive a level support base from the leveled first infill layer of the first layer of artificial turf, wherein the second layer provide a playing surface for the artificial turf athletic playing field.

### CROSS-REFERENCE TO RELATED APPLICATION

This application claims the benefit of U.S. Provisional Patent Application No. 62/692,590, titled Artificial Turf Field Apparatus and Method, filed Jun. 29, 2018, which is hereby incorporated by reference in its entirety.

### FIELD OF THE INVENTION

The present invention is related to artificial turf fields.

### BACKGROUND OF THE INVENTION

Artificial turf fields have been in use for many years and have gained special popularity in athletic playing surfaces. The grass like fibers and supporting infill provide performance and maintenance advantages over natural grass fields, and have a long but limited life. In implementation, artificial turf fields for athletic surfaces must typically meet certain performance characteristics including the specific ability to absorb shock (impact) at a level or range (designated for that field or sport). The developers and installers of artificial turf fields are tasked with meeting these requirements by designing the structure and arrangement of artificial turf fields in accordance with the specification for the field.

To meet the requisite shock absorbent characteristics, shock absorbing tiles, which are sometimes referred to as shock pads, are sometimes installed under the artificial turf. The pads in combination with the field (e.g., piles of fiber and infill particles) are designed to meet the level of shock absorption specified for a particular field when installed (and after installation, assuming there is no serious degradation).

It should be understood that there can be significant costs involved in the installation of a new artificial field. Artificial turf fields that have degraded to a state of performance that is below the specified performance characteristic for that field due to wear or outdoor exposure are typically^{,} replaced by removing the field. As part of this process, the infill particles from used fields can be removed and recycled for reuse in a new field. The removal, recycling, and installation of a new field can involve significant cost, time, and effort (including new materials for the infill). New and improved techniques are desired that can provide advances for artificial turf companies.

### SUMMARY

In accordance with embodiments of the present invention, an artificial turf athletic playing field is provided. The field comprises a first layer of artificial turf comprising artificial grass fibers tufted through a first backing and a first infill layer comprising infill particles interspersed between the tufted fibers, wherein the backing incorporates water drainage arranged by drainage openings dispersed throughout the backing that are covered by infill particles and tufted fibers, and wherein the infill layer has been leveled (e.g., by grooming, by adding aggregate, or other techniques) to be in a leveled condition; and a second layer of artificial turf comprising artificial grass fibers tufted through a first second backing and a second infill layer comprising infill particles interspersed between the tufted fibers, wherein the second layer is configured to receive a level support base from the leveled first infill layer of the first layer of artificial turf, wherein the second layer provide a playing surface for the artificial turf athletic playing field.

The artificial turf athletic playing field can be made of the first layer, which is adapted to cover a field to form a first artificial grass field. The first layer of artificial turf can be in a worn condition comprising turf fibers that are in a degraded condition because of field usage. The first layer of artificial turf can be a continuous artificial turf field. The infill of the first layer of artificial turf is preferably leveled using a drag or powered rotating brush mounted on a mobile chassis. The playing field is configured to have the first layer be in a shock absorption relationship to the second layer as a replacement to the installation of shock absorption pads. If desired, the first layer consists essentially of infill particles, artificial grass fibers, backing, and coating on the backing for the fibers. The combination of infill particles, artificial grass fibers, backing, and coating on the backing for the fibers, over the preexisting base of the first layer provides a predetermined of shock absorbent performance that is incorporated and implemented in installing the new field to the specific performance level required.

The artificial turf athletic playing field can be configured to have the second layer directly overlay over the first layer. The artificial turf athletic playing field being adapted such that the first layer positioned under second layer has a continuous or substantially continuous surface without breaks.

The first layer of the field is preferably adapted to be the supporting and shock absorbing structure for the second layer and the first layer implements the supporting and shock absorbing structure using loose elastomeric material (or loose elastomeric material and other material, e.g., sand, fibers, aggregates, etc.).

The infill particles in the first layer of the field can be made of resilient particles such as crumb rubber and sand, or any other infill (EPDM, TPE, Cork, etc.). For example, the infill particles of the first layer can comprise crumb rubber particles and sand only.

The infill in the first layer can be the original infill installed in the field.

A method of upgrading an artificial turf playing field can provided. The method can comprise leveling an infill layer of a first artificial turf field to be in a leveled condition, wherein the first artificial turf field comprises artificial grass fibers tufted through a first backing and a first infill layer comprising first infill particles interspersed between the tufted fibers, wherein the backing incorporates water drainage openings dispersed throughout the backing that are covered by first infill particles; and installing over the leveled first infill layer a second layer of artificial turf comprising artificial grass fibers tufted through a first second backing and a second infill layer comprising second infill particles interspersed between the tufted fibers.

The installing step can comprise overlaying the second layer over the first layer without placing additional materials on the first layer before installing the second layer. The installing step can comprise placing materials over the first layer before laying the backing of the second layer over the first artificial turf field. The method can involve reusing the first infill particles in a configuration that provides a level base and shock absorbency. The first infill particles can comprise sand and resilient particles (e.g., crumb rubber). The second infill particles can comprise sand and resilient particles. The method can further include depositing material in between the first artificial turf field and second layer of artificial turf.

The artificial athletic turf playing field can be configured to have, in a peripheral area of the field, the first layer comprising a flat surface and a plurality of aggregates that overly the flat surface, wherein the aggregates are adapted to have a height that tapers towards an outer edge of the peripheral area. The artificial athletic turf playing field can have the second backing positioned over (e.g., directly over) the plurality of aggregates and is attached to a nailer at an edge of the peripheral area.

The artificial athletic turf playing field can be configured to have in a peripheral area of the field, infill particles that are adapted to have a height that tapers to towards an outer edge of the peripheral area. The artificial athletic turf playing field can have the backing of the second layer positioned over the tapered infill particles and is attached to a nailer at an edge of the peripheral area.

Apparatus and methods are evident to those of skill in the art from the description herein without specifying that it is describing an apparatus, or method.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 is a diagram of cross sectional view of a portion of an artificial turf field in accordance with an embodiment of the present invention;

FIG. 2 is a diagram of an under side of an artificial turf field in accordance with an embodiment of the invention;

FIG. 3 is a diagram of an under side of an artificial turf field in accordance with an embodiment of the invention;

FIG. 4 is a diagram of an artificial turf field in accordance with an embodiment of the invention;

FIG. 5 is a view of a cross-section of a field at a perimeter of the field before the second layer is installed over the first layer in accordance with an embodiment of the invention;

FIG. 6 is a view of a cross-section of a field at a perimeter of the field before the second layer is installed over the first layer in accordance with an embodiment of the invention;

FIG. 7 is a view of cross section of the field of FIG. 5 after the second layer is installed in accordance with an embodiment of the invention; and

FIG. 8 is a view of cross section of the field of FIG. 6 after the second layer is installed in accordance with an embodiment of the invention; and

The illustrations are no drawn to be illustrative and scientific drawings.

### DETAIL DESCRIPTION OF THE INVENTION

In accordance with the principles of the present invention, new artificial turf fields are provided. The installation and use of artificial turf fields for play surfaces such as professional athletic fields for soccer or football have existed for many years. Embodiments of the present invention include aspects in which an existing artificial turf field, having a combination of artificial grass fibers and infill particles, is reused (rather removed) as the support based for a second artificial turf field that is overlayed on the first field, and therefore, provides a new playing surface at the same location (e.g., without requiring the removal of the first field). The infill particles in the first layer are kept in the first field (e.g., without recycling or cleaning) and are leveled with a sweeping brush that results in leveling the infill particles. The leveled infill particles provide a leveled support based for the installation of the second artificial turf The first artificial turf was originally configured and installed to provide certain playing field characteristics at the time of original installation such as the level of shock absorption (e.g., the standard(s) set by FIFA) and other characteristics which may have deteriorated over time (e.g., due to the artificial grass fibers wearing down). Even so, the first artificial turf field comprises a significant amount of elastomeric materials (or a combination of elastomeric material and other material in an artificial turf field) that provide a functional equivalent of a shock pad (which are shock absorption tiles that are installed under artificial turf fields to provide specified playing field characteristics). In some known system, material such as sand is deposited over a first layer such as an artificial turf field and is manipulated to provide a level base for the overlaying artificial turf field. The use of an intermediate sand layer increases costs and testing has shown that leveling the infill particles to provide a base achieves desired functional performance results (e.g., without including a leveling sand intermediate layer). In some prior art techniques, a second layer of artificial turf is placed over a first layer but the first layer is first modified to have certain new surface characteristics and in potentially others, a layer of sand is deposited and leveled that provides a level base.

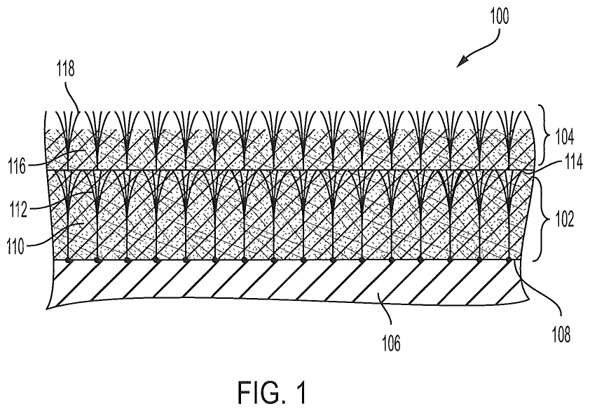

FIG. 1 illustrates a cross-sectional view of a portion of an artificial turf field having two layers of artificial turf structures. Now with reference to FIG. 1, artificial turf field 100 comprising first artificial turf layer 102 and second artificial turf layer 104. Artificial turf field 100 is positioned over support base 106, which can be a leveled ground support such as concrete or other material such as stone. First artificial turf layer 102 comprises backing 108, infill particles 110 and artificial grass fibers 112. Infill particles 110 are interspersed between artificial grass fibers 112. Second artificial turf layer 14 comprises backing 114, infill particles 116, and artificial grass fibers 118. Infill particles 116 are interspersed between artificial grass fibers 118,

The first artificial turf layer 102 may be a previously installed field that has worn due to usage over the years. The artificial fibers of the first layer 102 may have worn such that the field does not have the same playing performance or desired visual appearances. The fibers are worn or a significant percentage of the fibers are no longer at their original length or are otherwise damages (e.g., not their original smooth continuous shape). The condition of the first layer 102 can be such that it has reached the approximate end of its expected life or for some other reason is subject to replacement.

One solution is to remove and recycle the infill particles. In embodiments of the present invention, the first artificial turf layer 102 is retained without performing any significant modification, repair, or processing. A sweeping brush, a groomer, typically Laymor sweeping brush, which is often times used in artificial turf fields, is used to apply a grooming operation to first infill particles 110. The sweeping operation is used to achieve an even level of infill particles for the first artificial turf layer 102 and create a level base for second artificial turf layer 104. The leveled infill particles are in leveling support relationship with the second artificial turf layer 104.

Second artificial turf layer 114 is installed over first artificial turf layer 102. Before second artificial turf layer 104 is laid over first artificial turf layer 102, portions of first artificial grass fibers 112 may extend above the level of the first infill particles 110. When second artificial turf layer is laid over first artificial turf layer 102, the weight of the second artificial turf layer presses, pushes, or crushes fibers extending above the level of the first infill particles down into, on or towards the first infill particles. The level of the infill particles at the first layer 102 is consequently at about the height of the first layer 102 (once second layer 104 is installed).

In second artificial turf layer 104, once installed artificial fibers and infill particles together provide a playing surface for athletic activity. The fibers extend above the infill in similar visual fashion to a natural grass field.

First artificial turf layer 102 has a leveling and shock absorbent feature in relation to second artificial turf layer 104. In many known installation systems, a first layer of shock pads are installed. The term shock pad(s) are known to those of ordinary skill in the art as a particular articles of manufacture used in the installation of an artificial turf field. In embodiments of the present invention, shock pads are not installed in conjunction with installing the new artificial turf (the installation of the second layer). In aspects of embodiments of the present invention, first layer of artificial turf 102 provides the same or similar functional performance as shock pads without the added cost. The performance characteristics of the field 100 are as a result of the design rely on the integrated characteristics of the two layers (e.g., without including or integrating an integrated shock pad tiles in all or many portions of the field).

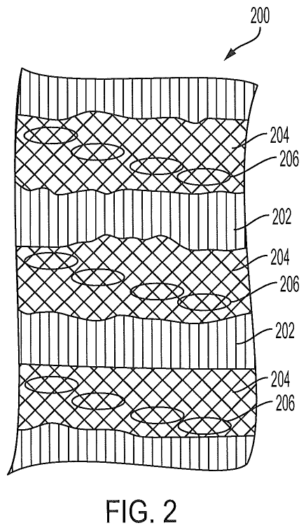

Backing 108 and backing 104 may have integrated water drainage features. For example, FIG. 2 shows illustrative backing 200 that can provide attachment for the fibers and water drainage functionality. Backing 200 comprises porous backing 202, coating material 204, and artificial turf fibers 206 (back side). Porous backing 202 is made of material having a weave or other pattern of materials that allows for water to drawing through backing 202. As such and as shown, drainage is dispersed through the backing 200. Coating material 204 is deposited in rows over portions on (backside) of backing 200 to cover and bind artificial turf fibers that have been tufted through backing 202. Coating material 204 holds the fibers in place to prevent the fibers from being pulled out. The coating material is not porous and water from outdoor weather would flow through porous backing 202. Backing 202 can be the backing for first artificial turf layer 102 (FIG. 1), second artificial turf layer 104 (FIG. 2), both. Porous backing 202 is preferably the sole or primary water drainage for its artificial turf layer (e.g., including a layer above) in that it is the way the field is designed to drain water, e.g., from the field having artificial turf field layer 102 of FIG. 1. The same can apply for second artificial turf layer 104. In implementation, porous backing 202 is covered with infill particles that are laid over the backing and interspersed between artificial turf fibers. This can be in both layers of artificial turf Water drains through the infill particles to reach porous backing 202.

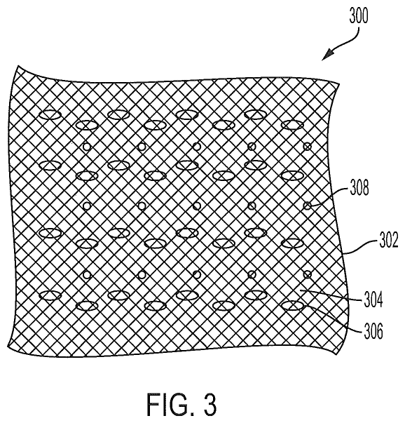

Other techniques in which water drainage is dispersed throughout backing are also contemplated. For example, FIG. 3 show illustrative backing 300 that includes holes such as needle holes (holes made by punctures), which are typically ¼ inch wide, that are made in the backing to provide water drainage. Backing 300 comprises backing material 302 (which can be a porous material) that has been covered with coating material 304. Coating material 304 covers and binds (backside) of artificial turf fibers 306 that have been tufted through backing material 302. before coating material 304 was applied. Coating material 304 is not porous. Backing 300 includes holes 308 that are provide water drainage for the artificial turf field. Holes 308 may have been formed by using a machine or instrument to puncture holes in backing 300. Holes 308 are preferably the sole or primary water drainage for its artificial turf layer (e.g., including a layer above) in that it is the way the field is designed to drain water, e.g., from the field having artificial turf field layer 102 of FIG. 1. The same can apply for second artificial turf layer 104. In implementation, porous backing 202 is covered with infill particles that are laid over the backing and interspersed between artificial turf fibers. This can be in both layers of artificial turf Water drains through the infill particles to reach holes 308.

Artificial turf fibers naturally extend upward and over the above interspersed drainage,

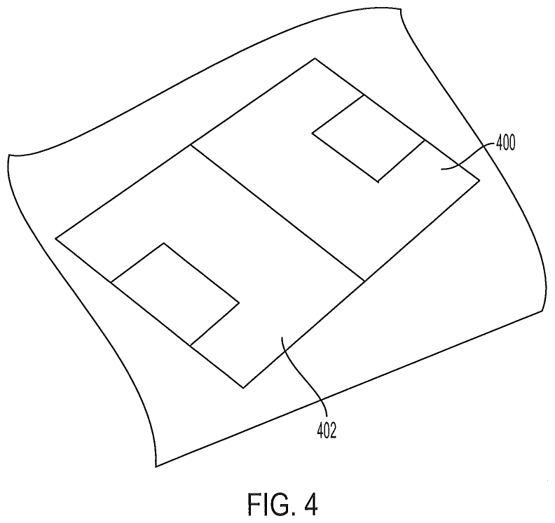

FIG. 4 shows an illustrative athletic playing field that is formed from the two layer structure illustratively described herein. Field 400 has a playing surface that is sufficient in size to play sports such as soccer, field hockey or football. Diagram 402 shows that the field is made of a structure of embodiments illustrated in FIG. 1. Field 400 can include a first field originally installed on that land and now covered by a new second layer of artificial turf. The first layer of artificial turf is a continuous artificial turf field that is reused as an underlying support and level base. The first layer can be reused without significant modification such as creating new drainage or significant repair. It can be a continuous or substantially continuous surface (without breaks) of artificial turf grass. A second layer of artificial turf is installed over the first layer. Water drainage is provided in each layer by means of porous backing, holes, or other drainage interspersed throughout the backing and covered by infill particles that are interspersed between fibers. Artificial turf fibers also lay over or cover the water drainage because of the natural position and configuration of the fibers (e.g., to resemble natural grass covering the ground).

Infill particles can include resilient particles such as crumb rubber or other similar material (e.g., crumbled elastomeric material having similar properties). Other particles or types of particles can be in the infill layer such sand, cork, or other material. An infill layer can include two or three (or more) layers and can involve different materials mixed to form a single layer.

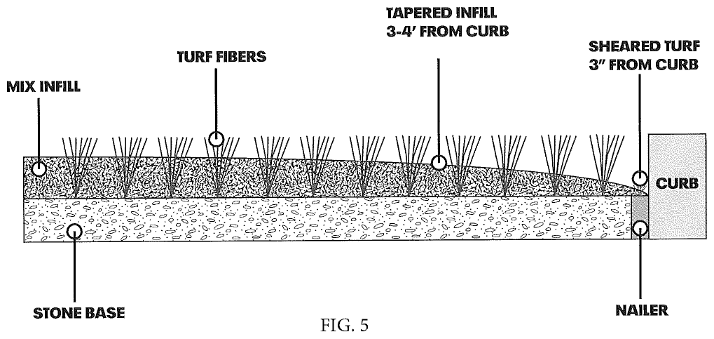

The existing artificial turf field can be prepared to receive the second layer at the perimeter of the field as part of the installation process. The existing field may have been installed by attaching the backing to a nailer at the edges of the field. The nailer is understood to those of ordinary skill in the art to be a wood board (or other type board or fixture) that is positioned at the far edge of the artificial turf field, around the field, under the backing and it has a top surface that is level with the ground (e.g., stone base for supporting the turf) for attaching the backing of the field at the edges of the field. In one installation approach, as shown in FIG. 5, an outside edge of the field perimeter can be sheared to provide a small area that has a relatively short fiber height (stubbly material shown in the figure) or flat surface. Some other operation other than shearing can also be used. The sheared surface can be an area that covers the nailer. The sheared area (or that area in general terms) can be used to attach the second backing to the nailer (e.g., using staples). The adjacent infill in the perimeter area can be adapted by grooming to have a slope, a taper, in which the height of the infill is gradually lowered from an existing height to approximately the height of the shaved area. The tapering is sloped towards the outer edge of the perimeter of the field. The second artificial turf field is installed by positioned its backing over the first field (including over the sloped and sheared area, for example). The artificial turf fibers and infill of the second layer can be adapted to generally match the height of the ground abutting the turf field for a generally smooth physical transition.

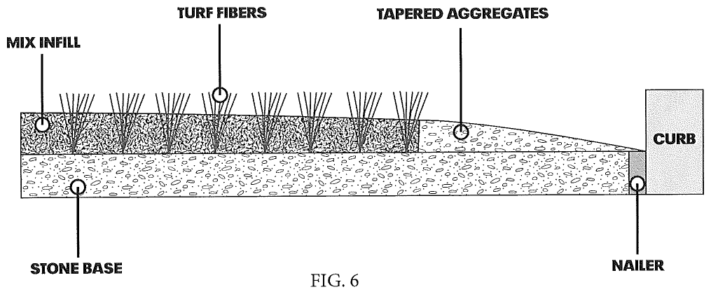

FIG. 6 illustrates a structure and process of installing the second field that is similar to FIG. 5. In this approach, material (fibers and infill) from the first field is removed (e.g., using shearing or other techniques) to provide a flat surface at a perimeter area of the field (e.g., running along the length of the field). As shown in the figures this can be an area in a perimeter of the field that is about 3 to 4 feet from the edge of the field (noted in FIGS. 5 and 6). The surface can be flat as a result of an operation to remove turf fibers and infill from that area. The cleared area can then be adapted by positioning aggregates such as stones over the surface and further adapting the plurality of aggregate to taper towards the outer edge of the perimeter area (e.g., up to an area above the nailer). The area above the nailer may have a flat surface (be clear of particles before the second layer is installed). The aggregates may have a starting height that is consistent with or matches the infill height at the point abutting the first layer (e.g., the existing infill height) and gradually slopes down from that point towards the edge. The aggregates may have been compacted at 95 proctor with a roller. The second backing for the second turf field is laid over the first field and it follows the shape of below it at the perimeter. The second backing can be attached at the nailer as part of installing the field. The second layer can be configured to have fibers and backing that approximately matches the height to ground at the edge abutting the turf field to provide a smooth physical transition. As shown, the area above the nailer is free of aggregates in this example and/or is flat.

Other techniques or combinations are contemplated as would be evident from the present disclosure. The installation process can involve having the perimeter of the field (e.g., the entire field) have such adaptation and second layer positioned over the adaption.

A surface is considered clear or flat even if it has some remnants or features hut overall provides a flat surface.

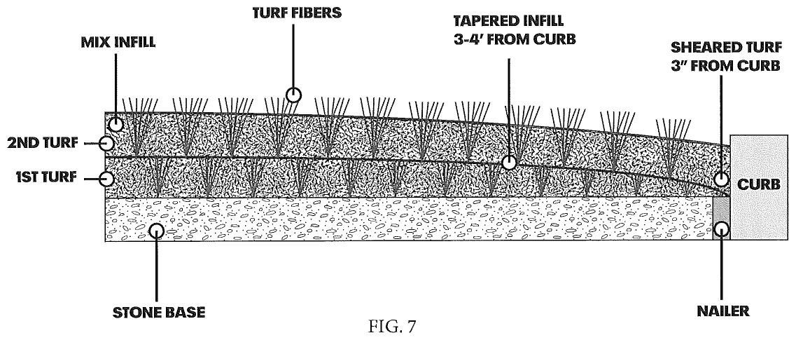

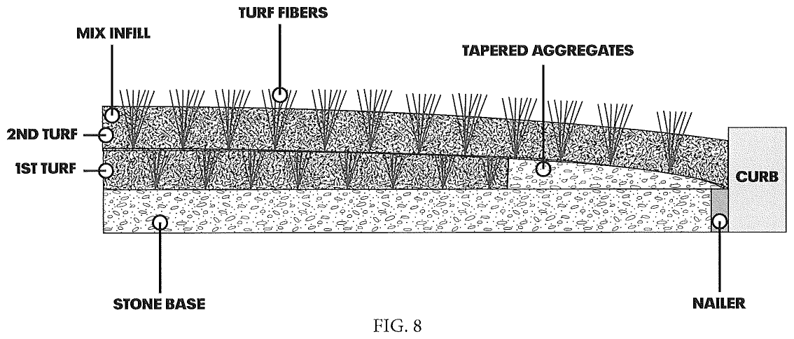

FIGS. 7 and 8 show an after view of FIGS. 5, and 6 respectively after the second layer is installed.

Artificial turf fibers can include monofilaments, slit film fibers, or others.

The terms “may” or “can” are used in a similar was as “is” to express that this is one embodiment and others may exist.

The use of “a” or “an” is general understood to mean one or more unless the context or convention understood by one of ordinary skill in the art would be different.

Any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

1. An artificial turf athletic playing field comprising:
a first layer of artificial turf comprising artificial grass fibers tufted through a first backing and a first infill layer comprising infill particles interspersed between the tufted fibers, wherein the backing incorporates water drainage arranged by drainage openings dispersed. throughout the backing that are covered by infill particles and tufted fibers, and wherein the infill infill layer has been leveled to be in a leveled condition; and
a second layer of artificial turf comprising artificial grass fibers tufted through a second backing and a second infill layer comprising infill particles interspersed between the tufted fibers, wherein the second layer is configured to receive a level support base from the leveled first infill layer of the first layer of artificial turf, wherein the second layer provide a playing surface for the artificial turf athletic playing field.

2. The artificial turf athletic playing field of claim 1 wherein the first layer covers a field to form a first artificial grass field.

3. The artificial turf athletic playing field of claim 1 wherein the first layer of artificial turf is in a worn condition comprising turf fibers that are in a degraded condition because of field usage.

4. The artificial turf athletic playing field of claim 1 wherein the first layer of artificial turf is a continuous artificial turf field.

5. The artificial turf athletic playing field of claim 1 wherein the infill of the first layer of artificial turf was leveled using a drag or powered rotating brush mounted on a mobile chassis.

6. The artificial turf athletic playing field of claim 1 wherein the playing field is configured to have the first layer be in a shock absorption relationship to the second layer as a replacement to installation of shock absorption pads.

7. The artificial turf athletic playing field of claim 1 wherein the first layer consists essentially of infill particles, artificial grass fibers, backing for fibers, and coating for fibers on backing.

8. The artificial turf athletic playing field of claim 1 wherein the second layer directly overlays the first layer.

9. The artificial turf athletic playing field of claim 1 wherein the first layer under second layer is a continuous or substantially continuous surface without breaks and/or contains primarily only elastomeric material throughout the first layer.

10. The artificial turf athletic playing field of claim 1 wherein first layer is configured to be the supporting and shock absorbing structure for the second layer and the first layer provides supporting and shock absorbing structure from loose elastomeric material.

11. The artificial turf athletic playing field of claim 1 wherein the infill particles in the first layer is at least composed of resilient particles.

12. The artificial turf athletic playing field of claim 1 wherein wherein the infill particles of the first layer comprises crumb rubber particles.

13. The artificial turf athletic playing field of claim 1 wherein the infill in the first layer is original infill installed in the first layer.

14. A method of upgrading an artificial turf playing field, comprising:
leveling an infill layer of a first artificial turf field to be in a leveled condition, wherein the first artificial turf field comprises artificial grass fibers tufted through a first backing and a first infill layer comprising first infill particles interspersed between the tufted fibers, wherein the backing incorporates water drainage openings dispersed throughout the backing that are covered by first infill particles; and
installing over the leveled first infill layer a second layer of artificial turf comprising artificial grass fibers tufted through a first second backing and a second infill layer comprising second infill particles interspersed between the tufted fibers.

15. The method of claim 14 wherein the installing comprises overlaying the second layer over the first layer without placing additional materials, on the first layer, before installing the second layer.

16. The method of claim 15 wherein the installing comprises placing materials over the first layer before laying backing of the second layer over the first artificial turf field.

17. The method of claim 14. wherein the first infill particles are being reused in a configuration that provides a level base and shock absorbency.

18. The method of claim 14 wherein the first infill particles comprises sand and resilient particles.

19. The method of claim 14 wherein the second infill particles comprises sand and resilient particles.

20. The method of claim 14 further comprising depositing material in between the first artificial turf field and second layer of artificial turf.

21. The artificial athletic turf playing field of claim 1 wherein, in a peripheral area of the field, the first layer comprises a flat surface above a nailer and adjacent to the flat surface, a plurality of aggregates, wherein the plurality of aggregates are adapted to have a height that tapers towards an outer edge of the peripheral area and end at or before reaching the flat surface.

22. The artificial athletic turf playing field of claim 21 wherein the second backing is positioned over the plurality of aggregates and is attached to the nailer at an edge of the peripheral area.

23. The artificial athletic turf playing field of claim 1 wherein, in a peripheral area of the field, the infill particles in the first layer comprises infill particles that are adapted to have a height that tapers towards an outer edge of the peripheral area.

24. The artificial athletic turf playing field of claim 1 wherein the backing of the second layer is positioned over the tapered infill particles and is attached to a nailer at an edge of the peripheral area.
